(19) United States
(12) Patent Application Publication
(10) Pub. No.: US 2022/0009222 A1
(43) Pub. Date: Jan. 13, 2022

(54) SEAL MEMBER FOR FLUID RESERVOIR

(71) Applicant: Hewlett-Packard Development Company, L.P., Spring, TX (US)

(72) Inventors: David Daniel Welter, Corvallis, OR (US); Kundan Singh, Singapore (SG); Tian Cheng Tang, Singapore (SG)

(73) Assignee: Hewlett-Packard Development Company, L.P., Spring, TX (US)

(21) Appl. No.: 17/288,525

(22) PCT Filed: Apr. 5, 2019
(86) PCT No.: PCT/US2019/025983

§ 371 Date: Apr. 24, 2021

(51) Int. Cl. B41F 31/02; F16J 15/3204

(52) U.S. Cl. CPC B41F 31/02; F16J 15/3204

(57) ABSTRACT

A seal member includes an annular seal body extending about a flow axis. The seal body has a first sealing face, second sealing face, and a step face. The first sealing face extends radially from the flow axis and has a planar contour. The second sealing face extends radially from the flow axis, is axially opposite the first sealing face, and has an arcuate contour. The step face extends radially from the flow axis and is defined axially between the first sealing face and the second sealing face, the step face arranged for capture between a spout and a reservoir body to capture the seal member. Fluid reservoirs and methods of making fluid reservoirs are also described.

### BACKGROUND

Many fluid systems, such as printers for a computer system in home and office applications, employ reservoirs for storing and dispensing liquids. For example, printers commonly use a printing fluid cartridge to supply printing fluid to a printing device for printing documents. The printing device progressively draws printing fluid from the printing fluid cartridge during operation until the printing fluid cartridge is empty, at which point a user or maintainer replaces or refills the printing fluid cartridge.

### BRIEF DESCRIPTION OF THE DRAWINGS

The following detailed description references the drawings, in which:

FIG. 1 is a schematic view of a fluid system constructed in accordance with the present disclosure according to an example, showing a fluid system including printing device connected to an printing fluid reservoir with captive seal member compressed between a bung and the printing fluid reservoir;

FIG. 2 is a schematic view of the example fluid device of FIG. 1, showing the seal member captive between a spout and the printing fluid reservoir, the bung displaced from the seal member such that fluid can be added to the fluid reservoir;

FIG. 3 is an exploded view of the example printing fluid reservoir of FIG. 1, showing the seal member and the spout displaced from the fluid reservoir;

FIG. 4 is cross-sectional view of the seal member of FIG. 1, showing a first sealing face and a second sealing face with a step face arranged axially between the first sealing face and the second sealing face;

FIG. 5 is cross-sectional view of the example printing fluid reservoir of FIG. 1, showing the captive seal member compressed between the bung and the fluid reservoir;

FIG. 6 is cross-sectional view of the example fluid reservoir of FIG. 1, showing an annular portion of the bung compressing the captive seal member to separate the interior of the fluid reservoir from the external environment when a cap carrying the bung in the closed position; and

FIG. 7 is a block diagram of an example of a method of making a printing fluid reservoir fora printing device, showing the operations of the method.

### DETAILED DESCRIPTION

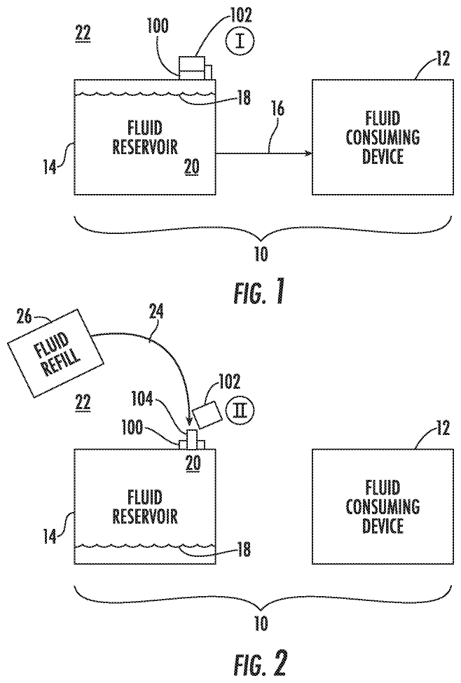

Reference will now be made to the drawings wherein like reference numerals identify similar structural features or aspects of the subject disclosure. For purposes of explanation and illustration, and not limitation, a partial view of a seal member in accordance with the disclosure is shown in FIG. 1 and is designated generally by reference character 100. Other implementations and examples of seal members, printing fluid reservoirs, and methods of making printing fluid reservoirs in accordance with the present disclosure, or aspects thereof, are provided in FIGS. 2-7, as will be described hereinbelow. The systems and methods described herein can be used for printing fluid reservoirs for printer devices, such as refillable printing fluid reservoirs employed in office printer devices, though the present disclosure is not limited to office printer devices or to printing fluid reservoirs in general.

Referring to FIG. 1, a fluid system 10, e.g., a printing fluid system, is shown. The fluid system 10 includes a fluid-consuming device 12, e.g., a printing device, and a fluid reservoir 14. The fluid-consuming device 12 is in fluid communication with the fluid reservoir 14 and is arranged to draw a fluid flow 16 from the fluid reservoir 14. The fluid reservoir 14 is disposed in fluid communication with the fluid-consuming device 12 to provide thereto the fluid flow 16. A fluid volume 18 occupies (in whole or in part) an interior 20 of the fluid reservoir 14 to provide the fluid flow 16.

In certain examples the fluid volume 18 is a liquid. In accordance with certain examples the fluid volume 18 is a printing fluid such as an ink composition, the fluid flow 16 is a printing fluid flow, and the fluid-consuming device 12 includes a printing device to print documents. Document printing by the fluid-consuming device 12 in turn progressively depletes the fluid volume 18 disposed within the interior 20 of the fluid reservoir 14. To allow additional fluid to be added to the fluid reservoir 14 for the fluid reservoir 14 includes a seal member 100 and a bung 102.

With reference to FIG. 2, the bung 102 is movable with respect to the seal member 100 between a closed position I (shown in FIG. 1) and an open position II (shown in FIG. 2). In the closed position I the bung 102 and the seal member 100 cooperate to separate the interior 20 of the fluid reservoir 14 (e.g., to avoid evaporation) from the external environment 22 for preservation of the fluid volume 18 contained within the interior 20 of the fluid reservoir 14. Separation is accomplished by compressive engagement of the seal member 100 by the bung 102. Specifically, compressive engagement of the seal member 100 by the bung 102 defines a barrier between the interior 20 of the fluid reservoir 14 and the external environment 22. In certain implementations the compressive engagement of the seal member 100 by the bung 102 is such that the interior 20 of the fluid reservoir 14 is hermetically sealed from the external environment 22.

In the open position II the bung 102 is displaced from the seal member 100. Displacement of the bung 102 disengages the bung 102 from the seal member 100 and exposes a spout 104. The spout 104 is fixed to the fluid reservoir 14 and is in communication with the interior 20 of the fluid reservoir 14. Displacement of the bung 102 places the external environment 22 in communication with the interior 20 of the fluid reservoir 14, allowing a volume of refill fluid 24 to be introduced into the interior 20 of the fluid reservoir 14 through the spout 104, such as from a fluid refill container 26. In certain examples the refill fluid 24 in a liquid. In accordance with certain examples the refill fluid 24 is printing fluid and fluid refill container 26 is a printing fluid refill container.

Sealing the fluid reservoir 14 from the external environment 22 may entail disposing the seal member 100 between the bung 102 and the fluid reservoir 14. This allows the bung 102 to compress the seal member 100 and form a barrier between the interior 20 of the fluid reservoir 14 and the external environment 22. Movement of the bung 102 between the closed position I (shown in FIG. 1) and the open position II can disturb the position of the seal member 100. Movement of the bung 102 can also displace the seal member 100 from the fluid reservoir 14. To avoid displacement and/or misplacement of the seal member 100 from the fluid reservoir 14 the seal member 100 is captive to the fluid reservoir 14. In this respect the seal member 100 remains in position in relation to the spout 104 irrespective of the position of the bung 102, the seal member 100 captive between the spout 104 and the fluid reservoir 14 and thereby providing reliable sealing to the fluid reservoir 14 irrespective of movement of the bung 102 between the closed position I and the open position II during refill events.

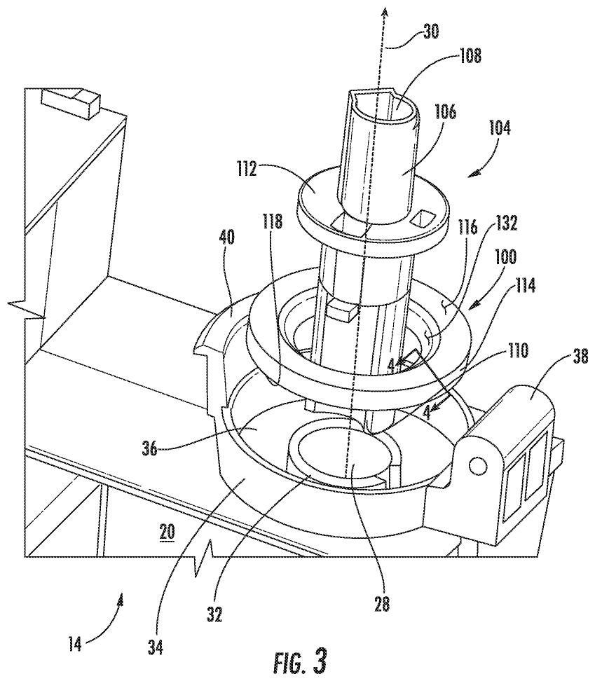

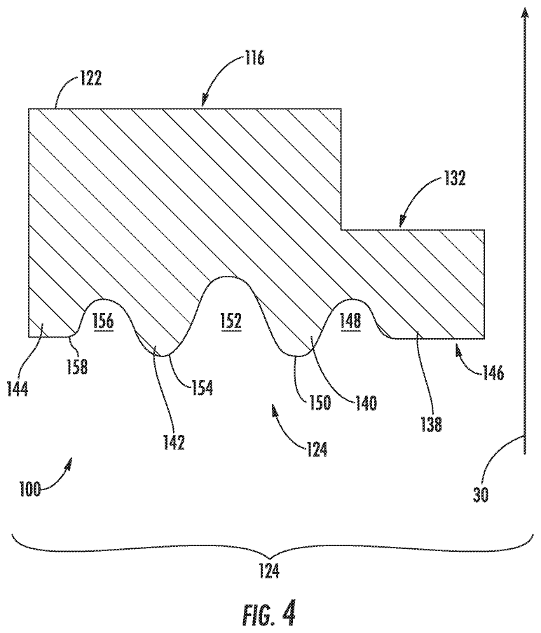

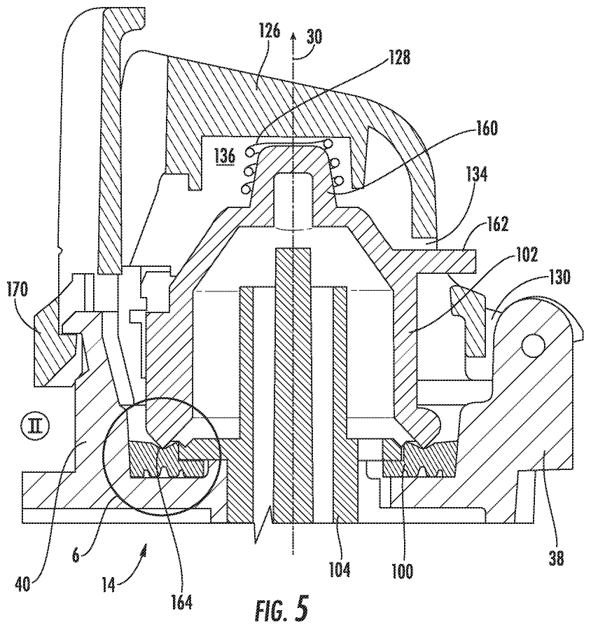

With reference to FIG. 3, a portion of the fluid reservoir 14 including the seal member 100 (with section lines referencing the cross-sectional view of FIG. 4 indicated) and the spout 104 are shown. The fluid reservoir 14 has a port 28. The port 28 defines a flow axis 30 which extends into the interior 20 of the fluid reservoir 14. A spout seat 32 extends circumferentially about the port 28 to seat the spout 104. A registration ring 34 extends circumferentially about the spout seat 32 and is radially separated from the spout seat 32 by a seal member groove 36. A hinge member 38 and a lock member 40 are arranged on circumferentially opposite sides of the port 28, the hinge member 38 arranged to pivotably support the bung 102 (shown in FIG. 1) for movement between the closed position I (shown in FIG. 1) and the open position II (shown in FIG. 2). The lock member 40 is arranged to fix the bung 102 in the closed position I once compressively engaged to the seal member 100.

The spout 104 has a tubular body 106 with an inlet 108 and an outlet 110 relative to the direction of flow through the spout 104 during refill of the fluid reservoir 14. The inlet 108 and the outlet 110 are arranged along the flow axis 30, the outlet 110 located within the interior 20 of the fluid reservoir 14 and the inlet 108 located outside of the fluid reservoir 14 while the spout 104 is fixed to the spout seat 32. A flange 112 is arranged along the spout 104 at a location between the inlet 108 and the outlet 110 for capturing, by axially abutting, the seal member 100 while the seal member 100 is arranged in the seal member groove 36 and the spout 104 seated on the spout seat 32.

The seal member 100 has an annular seal body 114. The annular seal body 114 has a first sealing face 116, a second sealing face 118, and a step face 132 (shown in FIG. 4). The first sealing face 116 extends radially from the flow axis 30 and has a planar contour 122 (shown in FIG. 4) (e.g., such that the first sealing face 116 extends about the flow axis 30). The second sealing face 118 extends radially from the flow axis 30 (e.g., such that the second sealing face 118 extends about the flow axis 30), is axially opposite the first sealing face 116, and has an arcuate contour 124 (shown in FIG. 4). The step face 132 extends radially toward the flow axis 30 from the first sealing face 116, e.g., such that the step face 132 extends about the flow axis 30, and is arranged axially between the first sealing face 116 and the second sealing face 118 for capture of the seal member 100 between the flange 112 of the spout 104 and the spout seat 32 of the fluid reservoir 14.

With reference to FIG. 4, the seal member 100 is shown in radial cross-section. The arcuate contour 124 is defined by two or more rib portions and two or more annular portions. In the illustrated example the arcuate contour 124 is defined by a radially inner annular portion 138, a radially inner rib portion 140, a radially outer rib portion 142, and a radially outer annular portion 144. The two or more rib portions and two or more annular portions provide redundant engagement to the underlying spout seat 32, improving sealing. Although shown and described herein having two rib portions and two annular portions, in certain examples the arcuate contour 124 can have more than two or fewer than two rib portions and/or annular portions, as suitable for an intended application. It is also noted that the adjective “radially” referred to in association with the radially inner annular portion 138, the radially inner rib portion 140, the radially outer rib portion 142, and the radially outer annular portion 144 describe the arrangement of the features in relation to the flow axis 30.

The radially inner annular portion 138 extends about the flow axis 30 and is axially overlapped by the step face 132. Axially opposite the step face 132 the radially inner annular portion 138 defines a radially inner planar surface 146 for frictional engagement with the seal member groove 36. It is also noted that the adjective “axially” referred to in the association of the step face 132 and the radially inner annular portion 138 is in relation to the flow axis 30.

The radially inner rib portion 140 extends circumferentially about the radially inner annular portion 138, is axially overlapped by the first sealing face 116, and is radially offset from the radially inner rib portion 140 by a radially inner arcuate recess 148. Axially opposite the first sealing face 116 the radially inner rib portion 140 defines a radially inner compression face 150 for compressive engagement with the seal member groove 36.

The radially outer rib portion 142 extends circumferentially about the radially inner rib portion 140, is axially overlapped by the first sealing face 116, and is radially offset from the radially inner rib portion 140 by a radially intermediate recess 152. Axially opposite the first sealing face 116 the radially inner rib portion 140 defines a radially outer compression face 154 for compressive engagement with the seal member groove 36. It is contemplated that the radially intermediate recess 152 have a greater axial depth than the axial depth of the radially inner arcuate recess 148. In one example, this may be desirable to accommodate the deformation of radially outer rib portion 142 and the radially inner rib portion 140 into the radially intermediate recess 152, limiting the radially outward ‘spread’ of the seal member 100 from the flow axis 30 to provide a relatively compact arrangement. This feature may be omitted in other implementations.

The radially outer annular portion 144 extends circumferentially about the radially outer rib portion 142, is axially overlapped by the first sealing face 116, and is radially offset from the radially outer rib portion 142 by a radially outer arcuate recess 156. Axially opposite the first sealing face 116 the radially outer annular portion 144 defines a planar surface 158 for engagement with the seal member groove 36. Optionally, the planar surface 158 has a radial width that is smaller than a radial width of the radially inner planar surface 146 of the radially inner annular portion 138. Providing the radially inner planar surface 146 with a radial width smaller than that of the radially inner annular portion 138 saves space, simplifying assembly of the seal member 100 and spout 104 on the fluid reservoir 14.

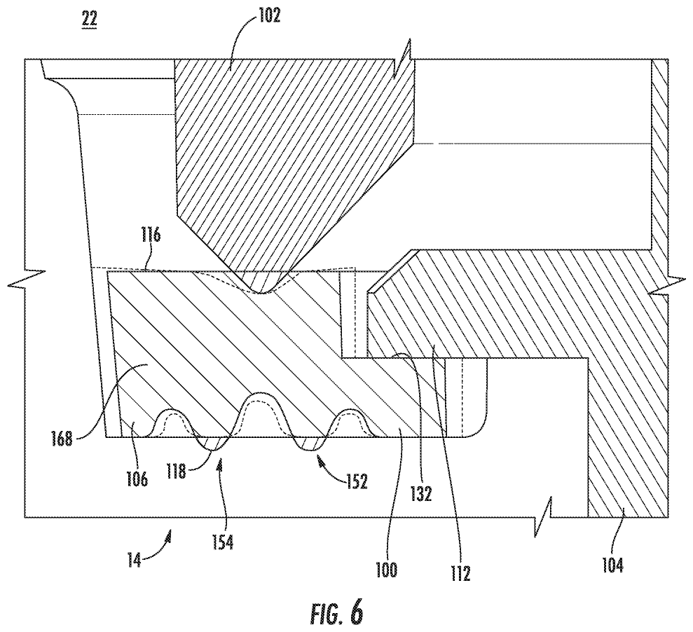

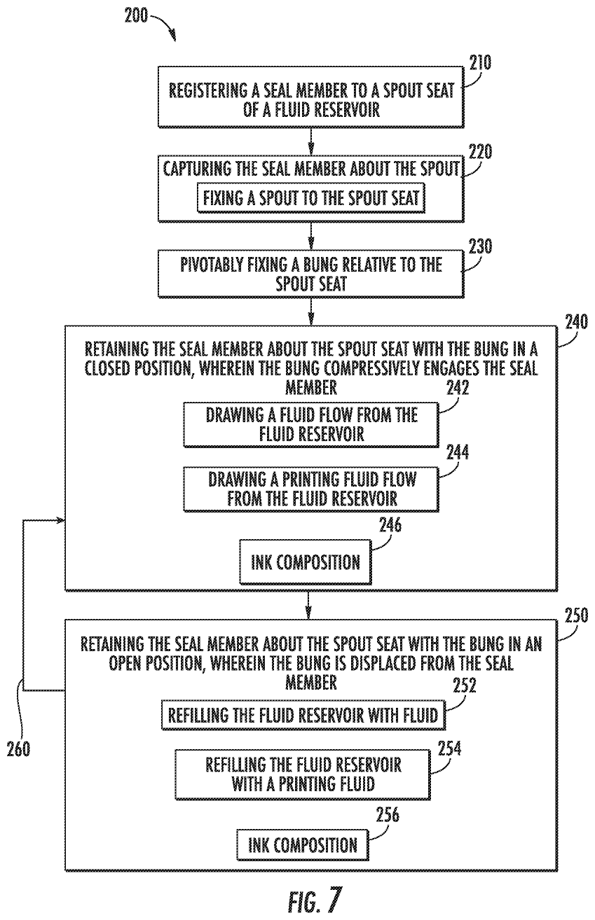

With reference to FIGS. 5 and 6, the seal member 100 is shown with the bung 102 in the closed position I and the blown up portion of FIG. 6 indicated by reference numeral 6. As shown in FIG. 5, the fluid reservoir 14 includes a cap 126 and a biasing member 128. The cap 126 carries the bung 102 and has a hinge tab 130 and a locking lever 170. The hinge tab 130 is radially offset from the flow axis 30 and is pivotably fixed in the hinge member 38. The locking lever 170 is arranged for locking engagement with the lock member 40 through operation of axially opposite jaws on the cap 126 and the lock member 40, respectively. A bung tab slot 134 and biasing member recess 136 are defined within the body of the cap 126.

The bung 102 has a biasing member seat 160, an alignment tab 162, and a sealing annulus 164. The biasing member seat 160 and the sealing annulus 164 are arranged on opposite ends of the bung 102, the biasing member seat 160 being additionally to seat thereon a biasing member 128, e.g., a spring. The alignment tab 162 is received within the bung tab slot 134 of the cap 126 and constrains the bung 102 in rotation and to within an axial movement range relative to the cap 126 such that the cap carries the bung 102 during movement between the closed position I and the open position II (shown in FIG. 2). The sealing annulus 164 extends about a face of the bung 102 opposing the seal member 100 and is arranged to compressively engage the seal member 100 while the bung 102 is in the closed position I, as shown in FIG. 5. The biasing member 128 is arranged between the cap 126 and the bung 102 and to urge the bung 102 away from the cap 126.

Urging the bung 102 away from the cap 126 urges the sealing annulus 164 against the seal member 100, and more specifically the first sealing face 116 when the bung 102 is in the closed position I. Application of force on the first sealing face 116 by the sealing annulus 164 compressively engages the seal member 100 against the fluid reservoir 14 at the second sealing face 118, for example by deforming the radially inner compression face 150 and the radially outer compression face 154, thereby forming a double barrier seal between the interior 20 (shown in FIG. 1) of the fluid reservoir 14 and the external environment 22 while the bung 102 is in the closed position I. Notably, while the bung 102 is in the open position II (shown in FIG. 2), abutment of the flange 112 to the step face 132 of the seal member 100 retains the seal member 100 against the fluid reservoir 14 in a captive arrangement.

It is contemplated that the magnitude of compressive force correspond with the position the cap 126 when locked and the spring constant of the biasing member 128, the bung 102 covering the spout 104. In this respect it is contemplated that the seal member 100 be formed from a resilient material 168, such as an elastomer by way of non-limiting example. The resilient material 168 allows the seal member 100 to deform to a compressed shape, shown in a dashed line outline in FIG. 5, and a nominal shape, shown in a solid line outline in FIG. 5. Examples of suitable resilient materials include low durometer thermal plastic elastomers, saturated elastomers, and unsaturated elastomers. In certain implementations the resilient material 168 includes polyisoprene, Santoprene, or ethylene propylene diene methylene rubber, which allow for fabrication of the features defined by the cross-sectional profile of the seal member 100 at relatively low cost.

With reference to FIG. 7, a method 200 of making a fluid reservoir is shown. The method 200 includes registering a seal member to a spout seat of a fluid reservoir, e.g., the seal member 100 (shown in FIG. 1) to the spout seat 32 (shown in FIG. 3) of the fluid reservoir 14 (shown in FIG. 1), as shown with box 210. Once registered with the spout seat the seal member is captured in the spout seat, as shown with box 220. It is contemplated that the seal member be captured to the spout seat by fixing a spout to the spout seat, e.g., the spout 104 (shown in FIG. 2).

As shown with box 230, the method 200 also includes pivotably fixing a bung, e.g., the bung 102 (shown in FIG. 1), to the spout seat. In certain examples the bung can be pivotably fixed by an intermediate cap, e.g., the cap 126 (shown in FIG. 5). In accordance with certain examples the bung can be biased away from the cap with a biasing member, e.g., the biasing member 128 (shown in FIG. 5), to urge the bung into compressive engagement with the seal member.

As shown with box 240, the method 200 additionally includes retaining the seal member against the seal seat with the bung in a closed position, e.g., the closed position I (shown in FIG. 1), the bung compressively engaging the seal member against the seal seat. The retention of the seal member about the spout seat is such that the compressive engagement of the bung to the seal member seals an interior of the fluid reservoir defining the seal seat, e.g., the interior 20 (shown in FIG. 1) of the fluid reservoir 14 (shown in FIG. 1), from the external environment. In certain implementations the fluid volume, e.g. the fluid volume 18 (shown in FIG. 1), is separated from the external environment by the seal member while drawn from the fluid reservoir by a fluid-consuming device connected to the fluid reservoir, e.g., the fluid-consuming device 12 (shown in FIG. 1). In certain examples a printing fluid is separated from the external environment by the seal member while drawn from the fluid reservoir by the fluid-consuming device, as shown with box 244. In certain implementations the printing includes an ink composition, as shown with box 246.

As shown with box 250, the method 200 further includes retaining the seal member against the seal seat with the bung in the open position, e.g., in the bung open position II (shown in FIG. 2), wherein the bung is displaced from the bung seat. While the bung is in the open position the fluid reservoir can be refilled, as shown with box 252. In certain examples the fluid reservoir can be refilled with a printing fluid, as shown with box 254. In certain implementations the printing fluid includes an ink composition, as shown with box 256. Retaining the seal member on the seal seat while the bung is displaced limits the likelihood that the seal member be displaced from the seal seat and/or misplaced during cyclic movement of the bung between the open position and the closed position. Further, in certain examples the seal member is retained about the seal seat when the fluid flow, e.g., the printing fluid and/or the ink composition, is drawn from the fluid reservoir as well as when the fluid reservoir is refilled, as shown with box 242, box 252, and arrow 260.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A seal member, comprising:
an annular seal body extending about a flow axis, the seal body having:
a first sealing face extending radially from the flow axis, the first sealing face having a planar contour;
a second sealing face extending radially from the flow axis and axially opposite the first sealing face, the second sealing face having an arcuate contour; and
a step face extending radially toward the flow axis from the first sealing face, wherein the step face is arranged axially between the first sealing face and the second sealing face for capture of the seal member.

2. The seal member as recited in claim 1, wherein the arcuate contour is defined by two or more rib portions extending about the flow axis, the two or more rib portions axially overlapped by the first sealing face of the seal body.

3. The seal member as recited in claim 1, wherein the arcuate contour is defined by a radially outer annular portion extending about the flow axis, the radially outer annular portion axially overlapped by the first sealing face of the seal body.

4. The seal member as recited in claim 1, wherein the arcuate contour is defined by a radially inner annular portion extending about the flow axis, radially inner annular portion axially overlapped by the step face of the seal body.

5. The seal member as recited in claim 1, wherein the arcuate contour is defined by:
a radially inner annular portion extending about the flow axis, the radially inner annular portion axially overlapped by the first sealing face of the seal body;
a radially inner rib portion extending about the radially inner annular portion, the radially inner rib portion axially overlapped by the first sealing face of the seal body;
a radially outer rib portion extending about the radially inner rib portion, the radially outer rib portion axially overlapped by the first sealing face of the seal body; and
a radially outer annular portion extending about the radially outer rib portion, the radially outer annular portion axially overlapping the first sealing face of the seal body.

6. The seal member as recited in claim 5, wherein the radially inner annular portion has a planar surface, wherein the radially outer annular portion has a planar surface, and wherein planar surface of the radially inner annular portion has a radial width that is greater than a radial width of the radially outer annular portion.

7. The seal member as recited in claim 5, wherein the radially inner rib portion is separated from the radially outer rib portion by a radially intermediate recess, wherein the radially outer annular portion is separated from the radially outer rib portion by a radially outer arcuate recess, and wherein the radially intermediate recess has a greater axial depth than the radially outer arcuate recess.

8. A fluid reservoir, comprising:
fluid reservoir having a spout seat;
a seal member as recited in claim 1, wherein the seal body extends about the spout seat;
a spout with a flange fixed to the spout seat, wherein the flange axially abutting the step face of the seal body such that the seal member is captive between the flange and the fluid reservoir; and
a bung pivotably fixed to a body of the fluid reservoir and movable between an open position and a closed position, the bung compressively fixing the seal member between the bung and the fluid reservoir in the closed position, the seal member captive between the spout and the fluid reservoir while the bung is in the open position.

9. The fluid reservoir as recited in claim 8, wherein the bung has biasing member seat and a sealing annulus arranged on opposite ends by the bung, the sealing annulus compressively engaging the first sealing face of the seal member in the closed position.

10. The fluid reservoir as recited in claim 8, further comprising a cap pivotably fixed to the fluid reservoir, wherein the bung is carried by the cap between the open position and the closed position.

11. The fluid reservoir as recited in claim 10, further comprising a biasing member arranged between the bung and the cap, the biasing member arranged to urge the bung away from the cap.

12. The fluid reservoir as recited in claim 10, wherein the cap has a locking lever, wherein the fluid reservoir has a lock member, and wherein the locking lever engages the lock member while the bung is in the closed position.

13. The fluid reservoir as recited in claim 8, wherein the fluid reservoir has an interior, wherein the interior is occupied by printing fluid.

14. The fluid reservoir as recited in claim 8, further comprising a printing device in fluid communication with the fluid reservoir.

15. A method of making a fluid reservoir, comprising:
registering a seal member to a spout seat;
capturing the seal member about the spout seat by fixing a spout to the spout seat; and
pivotably fixing a bung relative to the spout seat; and
retaining the seal member about the spout seat with the bung in a closed position, wherein the bung compressively engages the seal member; and
retaining the seal member about the spout seat with the bung in an open position, wherein the bung is displaced from the seal member.
